(19) United States
(12) Patent Application Publication
(10) Pub. No.: US 2007/0298336 A1
(43) Pub. Date: Dec. 27, 2007

(54) Carrier coating

(75) Inventors: Robert Bayley, Fairport, NY (US); Grazyna Kmiecik-Lawrynowicz, Fairport, NY (US); Maura Sweeney, Irondequoit, NY (US)

Correspondence Address: PILLSBURY WINTHROP SHAW PITTMAN LLP, P.O BOX 10500, McLean, VA, 22102, US

(73) Assignee: Xerox Corporation, Stamford, CT (US)

(21) Appl. No.: 11/473,450

(22) Filed: Jun. 23, 2006

(51) Int. Cl. G03G 13/00

(52) U.S. Cl. 430/31; 430/464; 430/493; 430/486; 430/45.56; 430/118.6; 430/123.41; 430/499; 430/137.1; 430/281.1; 430/286.1; 524/430; 524/556

(57) ABSTRACT

A carrier coating that may be used to coat carrier particles, including a specific additive that imparts the coating with superior storage stability and wherein the carrier coating includes an acrylic-based polymeric powder obtained from an emulsion of an acrylic-based polymer, a surfactant, a cationic initiator, and a conductive filler.

### BACKGROUND

Herein disclosed are embodiments that relate generally to carrier particles that may be used to form toner. More particularly, the embodiments relate to carrier coating for xerographic carriers which has longer storage life than conventional carrier coatings. The incorporation of a specific additive, in embodiments, provides a coating with superior storage stability.

The electrostatographic process, and particularly the xerographic process, involves the formation of an electrostatic latent image on a photoreceptor, followed by development of the image with a developer, and subsequent transfer of the image to a suitable substrate. Numerous different types of xerographic imaging processes are known wherein, for example, insulative developer particles or conductive developer particles are selected depending on the development systems used. It is of great importance that such developer compositions are associated with the appropriate triboelectric charging values as it is these values that enable continued formation of developed images of high quality and excellent resolution. In two component developer compositions, carrier particles are used in charging the toner particles.

The resulting toners can be selected for known electrophotographic imaging and printing processes, including digital color processes, and are especially useful for imaging processes, specifically xerographic processes, which usually require high toner transfer efficiency such as those having a compact machine design without a cleaner or those that are designed to provide high quality colored images with excellent image resolution and signal-to-noise ratio and image uniformity, and for imaging systems wherein excellent glossy images are generated.

Carrier particles in part consist of a roughly spherical core, often referred to as the “carrier core,” which may be made from a variety of materials. The core is typically coated with a resin. This resin may be made from a polymer or copolymer. The resin may have conductive material or charge enhancing additives incorporated into it to provide the carrier particles with more desirable and consistent triboelectric properties. The resin may be in the form of a powder, which may be used to coat the carrier particle. Often the powder or resin is referred to as the “carrier coating” or “coating.”

Various coated carrier particles for use in electrostatographic developers for the development of electrostatic latent images are described in patents. For example, U.S. Pat. No. 3,590,000 discloses carrier particles that may consist of various cores, including steel, with a coating thereover of fluoro-polymers and ter-polymers of styrene, methacrylate, and silane compounds.

One common way of obtaining carrier coating is in the form of powder via emulsion polymerization. This particular method of polymerization has been described in patents, for example, U.S. Pat. Nos. 6,042,981 and 5,290,654, incorporated herein by reference. Emulsion polymerization, yielding excellent control over particle size and size distribution, is most typically accomplished by the continuous addition of monomer to a suitable reaction vessel containing water. The reaction vessel is provided with stirring means, and also optionally, nitrogen atmosphere and thermostatic control. The polymerization is affected by heating to, for example, between about 40° C. and about 85° C., and with the addition of an appropriate initiator compound, such as ammonium persulfate. The polymer or copolymer powders is isolated by freeze drying in vacuo or by conventional spray drying the residue-free latex. The resulting polymer particle diameter size is, for example, from about 0.1 to about 12.0 microns in volume average diameter, but exhibits excellent friability when blended with a bare carrier core.

The problem with conventional powder carrier coatings, however, is that the storage stability of the emulsion prior to coating and spray drying is very low—for example, about 4 to 5 weeks. Thus the product obtained from the emulsion polymerization must be used to soon after the emulsion is formed. This extremely narrow timeframe of stability presents serious risks in the case of unforeseen delays in shipping or spray drying.

Thus, there is a need for a carrier coating that has longer storage life so that it provides more flexibility in its use. Further, it is desirable that such a carrier coating maintains the other desirable qualities such as good coating coverage and triboelectric charging capabilities.

### BRIEF SUMMARY

Embodiments include a composition for coating carrier particles comprising an acrylic-based polymeric powder including a surfactant and a cationic initiator, wherein the acrylic-based polymeric powder is obtained from an emulsion of the acrylic-based polymer, the surfactant and the cationic initiator, and a conductive filler.

Another embodiment provides a composition for coating carrier particles comprising a generally uniform dispersion of from about 0.18 percent to about 3.0 percent by weight of the composition of an acrylic-based polymeric powder, a surfactant and a cationic initiator, and a conductive filler of from about 10 percent to about 25 percent by weight of the composition, wherein the cationic initiator is 2,2′-Azobis(2-methylpropionamidine)dihydrochloride.

Another embodiment provides a carrier particle for use in xerographic developer, wherein the carrier particle comprises a core having a composition coating thereon, the composition coating comprising an acrylic-based polymeric powder obtained from an emulsion of an acrylic-based polymer, a surfactant, a cationic initiator, and a conductive filler.

Yet another embodiment provides a developer comprising toner, and carrier particles, wherein the carrier particles comprise a core having a composition coating thereon, the composition coating comprising an acrylic-based polymeric powder obtained from an emulsion of an acrylic-based polymer, a surfactant, a cationic initiator, and a conductive filler.

### DETAILED DESCRIPTION

In the following description, it is understood that other embodiments may be used and structural and operational changes may be made without departing from the scope of the present embodiments.

The present embodiments relate to coating composition for carrier particles that, in embodiments, exhibit longer storage life than conventional carrier coatings. The incorporation of a specific additive, in embodiments, provides the coating with superior storage stability.

More specifically, in embodiments the latexes are generated as follows. The polymerization of these latexes occurs in the temperature range from about 50° C. to about 90° C. The polymerization of the latexes is accomplished by heating at an effective temperature such as from about 50° C. to about 90° C. For the polymerization, there are usually selected known initiators, such as radical initiators capable of initiating a free radical polymerization process. Examples of initiators include cationic water soluble free radical initiators. The initiator concentration employed is, for example, from about 0.05 to about 5 weight percent of the total weight of monomer to be polymerized, and which amount is determined by the desired molecular weight of the resin. As the initiator concentration is decreased relative to the weight of molar equivalents of monomer used, the molecular weight of the thermoplastic resin product generally increases. Free radical initiators useful in the present invention include any cationic free radical initiator that is capable of providing free radical species upon heating to above about 30° C.

Embodiments relate to the emulsion polymerization of methyl methacrylate with acrylic acid, methacrylic acid and β-Carboxyethylacrylate. The cationic initiator 2,2′-Azobis(2-methylpropionamidine)dihydrochloride (“ABAM”) is also included in the emulsion.

Other water-soluble cationic initiators in the context of the invention include compounds, for example, 2,2′-azobis(N,N′-dimethylene isobutyramidine) dihydrochloride, 2,2′-azobis(2-amidinopropane) dihydrochloride, 2,2′-azobis(N,N′-dimethylene isobutyramidine), 2,2′-azobis-2-methyl)-N-[1,1 bis(hydroxymethyl]propionamide, 2,2′-azobis-2-methyl-N[1,1 bis(hydroxymethyl)ethyl]propionamide, 2,2′-azobis(isobutyramide)dihydrate, 2,2′-azobis(2-methyl-N-phenylpropionamidine) dihydrochloride, 2,2′-azobis[N-(4-chlorophenyl)-2-methylpropionamidine] di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine] dihydrochloride, 2,2′-azobis[2-methyl-N-2-propenylpropionamidinejdihydrochloride, 2,2′-azobis[N-(2-hydroxy-ethyl)2-methylpropionamidine]dihydrochloride, 2,2′-azobis[2(5-methyl-2-imidazolin-2-yl)propane] dihydrochloride, 2,2′-azobis[2-(2-imidazolin-2-yl)propane]dihydrochloride, 2,2′-azobis [2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin -2-yl)propane]dihydrochloride and 2,2′-azobis{2-[1-(2-hydroxyethyl)-2-imidazolin-2-yl]propane}dihydrochloride.

Reactive monomers examples include unsaturated compounds that react with the free radical initiator compounds or propagating free radical species, and which monomers can be selected in various effective amounts, such as from about 1 to about 98 weight percent based on the total weight of polymerization reaction components. The monomer or monomers used are substantially water insoluble, generally hydrophobic, and can be readily dispersed in the formed aqueous phase with adequate stirring when added to the reaction vessel. The dispersal of the reactive monomers can be further enhanced and assisted by an in situ stabilization or oligosurfactant formation resulting from the free radical addition reaction of the water soluble cationic initiator, such as 2,2′-Azobis(2-methylpropionamidine)dihydrochloride, to the added reactive monomers. Optionally, anionic, nonionic or cationic surfactants may be used to assist the dispersion process.

Using this additive as an initiator in producing the conventional carrier coatings have provided a latex with superior storage stability. For example, synthesized latex copolymer of methylmethacrylate-co-methacrylic acid, with an intial particle size of about 80 nanometers and about 0.03 width, was found to remain stable in excess of one year, which greatly surpasses the storage stability of conventional coatings prepared with commonly used anionic initiator ammonium persulfate.

Polymers that may be used in the present embodiments are any suitable polymer or copolymer which retain a suitable particle size for use in the carrier coating as described herein, for example, an acrylic-based polymer such as methyl methacrylate copolymer formed from an acrylic acid, methacrylic acid or β-carboxyethylacrylate. In one embodiment, a methyl methacrylate polymer or copolymer is used as the polymer generated as a latex emulsion. Suitable comonomers that may be used to form a PMMA copolymer include, for example, monoalkyl or dialkyl amines such as dimethylaminoethyl methacrylate, diethylaminoethyl methacrylate, diisopropylaminoethyl methacrylate, acrylic or methacrylic acids, or fluoroalkyl or perfluorinated acrylic and methacrylic esters, such as, for example fluoro-ethyl methacrylate or fluoro-ethylacrylate. 2,2,2 trifluoro-ethyl methacrylate is an especially preferred fluoro-ethyl methacrylate.

In another embodiment the monomers, polymers and copolymers which may be selected may include such monomers, polymers or copolymers that are suitable for conventional emulsion polymerization processes; specific examples of monomers include, but are not limited to, those used for obtaining polymethylmethacrylate resins, styrene/acrylate resins, styrene/methacrylate resins and vinyl resins. Suitable homopolymer adjuncts of the base polymer resin would be vinyl resins including homopolymers or copolymers of one or more vinyl monomers. Typical examples of vinyl monomeric units include, but are not limited to, styrene, p-chlorostyrene, vinyl naphthalene, vinyl chloride, vinyl bromide, vinyl fluoride, ethylenically unsaturated monoolefins such as ethylene, propylene, butylene, isobutylene and the like; vinyl esters such as vinyl acetate, vinyl propionate, vinyl benzoate, vinyl butyrate, and the like; esters of alphamethylene aliphatic monocarboxylic acids such as methyl acrylate, ethyl acrylate, n-butyl acrylate, isobutyl acrylate, dodecyl acrylate, n-octyl acrylate, 2-chloroethyl acrylate, phenyl acrylate, methylalphachloroacrylate, ethyl methacrylate, butyl methacrylate and the like; acrylonitrile, methacrylonitrile, acrylamide, vinyl ethers such as vinyl methyl ether, vinyl isobutyl ether, vinyl ethyl ether and the like; vinyl ketones such as vinyl methyl ketone, vinyl hexyl ketone, methyl isopropenyl ketone and the like; vinylidene halides such as vinylidene chloride, vinylidene chlorofluoride and the like; N-vinyl indole, N-vinyl pyrrolidene and the like; dienes, such as butadiene and isoprene and the like; and mixtures thereof.

Surfactants in amounts of, for example, 0.1 to about 5 percent by weight selected in embodiments include, for example, nonionic surfactants such as dialkylphenoxypoly(ethyleneoxy)ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™. An effective concentration of the nonionic surfactant is in embodiments, for example, from about 0.1 to about 5 percent by weight, and preferably from about 0.4 to about 1 percent by weight of monomer, or monomers selected to prepare the copolymer resin of the emulsion.

Examples of ionic surfactants include sodium dodecylsulfate (SDS), sodium dodecylbenzene sulfonate, sodium dodecylnaphthalene sulfate, dialkyl benzenealkyl, sulfates and sulfonates, available from Aldrich, NEOGEN R™, NEOGEN SC™. obtained from Kao, and the like. An effective concentration of the anionic surfactant generally employed is, for example, from about 0.1 to about 5 percent by weight, and preferably from about 0.4 to about 1 percent by weight of monomers or monomer used to prepare the copolymer emulsion.

Examples of anionic surfactants that can be selected in various effective amounts, such as from about 0.1 to about 5 weight percent, include sodium dodecylbenzene sulfonate, sodium dodecylnaphthalene sulfate, dialkyl benzenealkyl, sulfates and sulfonates, available from Aldrich, NEOGEN R™, NEOGEN SC™. obtained from Kao, and the like. They can also be selected from nonionic surfactants, such as polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate and the like. In embodiments, known cationic surfactants can be selected for the emulsion resin blend, such as an alkylbenzalkanium halide and the like.

The monomer or monomer mixture is gradually mixed into an aqueous solution of surfactant such that only 5 percent to 30 percent of the total amount of monomer, is emulsified, preferably while maintaining continuous mixing. Initiation of polymeric latex particles is accomplished by rapid addition of cationic initiator 2,2′-Azobis(2-methylpropionamidine)dihydrochloride solution, followed by a metered addition of the remaining monomer supply. Metered rate is about 0.1 to about 5.0 grams per minute, preferably at about 2.0 grams per minute, or a feed rate of about 128 minutes, for latex preparations. The mixing is continued after addition of the final amount of monomer to complete conversion. Temperature is also maintained within a preferred range of 78° C. to 82° C.

The mixing is performed at a rate of, for example, about 50 to about 300 revolutions per minute for about 5 to 6 hours using any mechanical mixing apparatus well known in the art. Preferably, the mixing is performed at a rate of about 100-200 revolutions per minute for about 5 to about 6 hours, with temperature between 78° C. to 82° C. to complete conversion.

The surfactant is added in an amount of about 0.1 percent to about 5 percent by weight of the monomer polymerized. In an embodiment, the surfactant is sodium lauryl sulfate (“SLS”) in the range of about 0.4 percent to about 1.0 percent by weight of the monomer to be polymerized. In embodiments, the initiator is 2,2′-Azobis(2-methylpropionamidine)dihydrochloride in a range of about 0.05 percent to about 1.2 percent by weight of the monomer. By procedures well known to the art, surfactant concentration is used to regulate latex particle size, while initiator level is used to regulate the molecular weight of the polymer produced.

The recovery of the polymer particles from the emulsion suspension can be accomplished by processes known in the art. For example, the emulsion of polymer particles can first be filtered by any suitable material. In another embodiment, a cheese cloth is used. The polymer particles can then be washed, but in a preferred embodiment, the polymer particles are not washed, thus allowing some amount of the surfactant to remain in association with the conductive polymer particles. Allowing some amount of the surfactant to remain in association with the polymer particles provides for better particle formation and better carrier coating characteristics. The surfactants' interplay with the surface chemistry of the polymer particles provides for these improved results. Finally, the polymer particles are dried using, e.g., freeze drying, spray drying or vacuum techniques well known in the art.

The polymer particles isolated from the process have an initial size of, for example, from about 1 micrometers to 7 micrometer. Due to physical aggregates, some of the polymer particles may initially have a size larger than 7 micrometer. During the mixing process with the conductive filler and/or the carrier cores, the physical aggregates of the polymer particles will be broken up into smaller polymer particles. Preferably, the polymer particles obtained by the process herein have a size of, for example, from about 1 micrometers to about 7 micrometers, or from about 1 micrometers to about 6 micrometers.

After the formation and recovery of the polymer particles, at least one conductive filler is incorporated with the polymer particles. The inclusion of conductive filler into carrier coating composition is well known in the xerographic arts. Various types of conductive filler may be incorporated into the present embodiments. The conductive material described may be any suitable material exhibiting conductivity, e.g., metal oxides like tin oxide, metals, carbon black, and the like, whose size and surface area provide the proper conductivity range. An exemplary carbon black is VULCAN XC72 (available from Cabot Corporation; Boston, Mass.), which has a particle size of about 0.03 micrometers, and a surface area of about 250 m²/g. The coating composition described herein enables carriers to achieve a wide range of conductivity. Carriers using the composition may exhibit conductivity of from about 10⁻⁷ to about 10⁻¹⁷ mho-cm⁻¹ as measured, for example, across a 0.1 inch magnetic brush at an applied potential of 10 volts; and wherein the coating coverage encompasses from about 10 percent to about 100 percent of the carrier core.

The conductive filler is incorporated into the polymer particles using techniques well known in the art including the use of various types of mixing and/or electrostatic attraction, mechanical impaction, dry-blending, thermal fusion and others. The composition may contain from about 0 percent to about 60 percent by weight conductive filler, although in some embodiments the micro-powder may contain only about 10 percent by weight of a conductive filler.

In addition to incorporating conductive filler into carrier coatings, it is often desirable to impart varying charge characteristics to the carrier particle by incorporating charge enhancing additives. If incorporated with the sub-micron sized polymer particles, the charge enhancing additives may be incorporated in a premixing process before or after the incorporation of the conductive filler.

Typical charge enhancing additives include particulate amine resins, such as melamine, and certain fluoro polymer powders such as alkyl-amino acrylates and methacrylates, polyamides, and fluorinated polymers, such as polyvinylidine fluoride (PVF₂) and poly(tetrafluoroethylene), and fluoroalkyl methacrylates such as 2,2,2, trifluoroethyl methacrylate. Other charge enhancing additives such as, for example, those illustrated in U.S. Pat. No. 5,928,830, incorporated by reference herein, including quaternary ammonium salts, and more specifically, distearyl dimethyl ammonium methyl sulfate (DDAMS), bis-1-(3,5-disubstituted-2-hydroxy phenyl)axo-3-(mono-substituted)-2-naphthalenolato(2-) chromate(1-), ammonium sodium and hydrogen (TRH), cetyl pyridinium chloride(CPC), FANAL PINK.RTM. D4830, and the like and others as specifically illustrated therein may also be utilized in the present embodiments.

The charge additives are added in various effective amounts, such as from about 0.01 percent to about 15.0 percent by weight, based on the sum of the weights of all polymer, conductive additive, and charge additive components.

After the synthesis of the coating composition, including the incorporation of conductive filler and optional charge enhancing additives, the resin may be incorporated onto the surface of the carrier. Various effective suitable processes can be selected to apply a coating to the surface of the carrier particles. Examples of typical processes for this purpose include roll mixing, tumbling, milling, shaking, electrostatic powder cloud spraying, fluidized bed, electrostatic disc processing, and an electrostatic curtain. For example, see U.S. Pat. No. 6,042,981, incorporated herein by reference.

Following incorporation of the coating composition onto the surface of the carrier, heating may be initiated to permit flow of the coating material over the surface of the carrier core. In a preferred embodiment, the coating composition is fused to the carrier core in either a rotary kiln or by passing through a heated extruder apparatus.

In an embodiment, the conductive polymer particles are used to coat carrier cores of any known type by any known method, which carriers are then incorporated with any known toner to form a developer for xerographic printing. Suitable carriers may be found in, for example, U.S. Pat. Nos. 4,937,166 and 4,935,326, incorporated herein by reference, and may include granular zircon, granular silicon, glass, steel, nickel, ferrites, magnetites, iron ferrites, silicon dioxide, and the like.

Carrier cores having a diameter in a range of, for example, about 30 micrometers to about 400 micrometers may be used. In further embodiments, the carriers are, for example, about 35 micrometers to about 100 micrometers.

Typically, the coating composition covers, for example, about 10 percent to about 100 percent of the surface area of the carrier core using from about 0.18 percent to about 2.0 percent coating weight, or from about 0.8 percent to about 1.5 percent coating weight.

The use of the carrier coating composition disclosed herein provides significant advantages over the prior art carrier coatings, namely the coating exhibits enhanced stability and significantly increased storage life. In addition, the cationic initiator 2,2′-Azobis(2-methylpropionamidine)dihydrochloride incorporated into the composition to impart this enhanced stability may also serve as a direct substitute for ammonium persulfate. The inclusion of 2,2′-Azobis(2-methylpropionamidine)dihydrochloride has been shown not to adversely affect other desirable qualities of the composition, including coating coverage, predictable tribolelectric charging rate, durability, and excellent control over the A zone/C zone sensitivity.

The coating composition of the present embodiments finds particular utility in a variety of xerographic copiers and printers, such as high speed xerographic color copiers, printers, digital copiers and more specifically, wherein color copies with excellent and substantially no background deposits are desirable in copiers, printers, digital copiers, and the combination of xerographic copiers and digital systems.

### EXAMPLES

The examples set forth hereinbelow are being submitted to illustrate embodiments of the present disclosure. These examples are intended to be illustrative only and are not intended to limit the scope of the present disclosure. Also, parts and percentages are by weight unless otherwise indicated. Comparative examples and data are also provided.

### Comparative Example I

### Synthetic Latex Example 32

### Ammonium Persulfate Initiated (Molecular Weight (M_{w}) of about 700,000)

A latex copolymer comprised of methyl methacrylate (MMA)/methacrylic acid (MAA) of 99/1 parts (by weight throughout unless otherwise indicated) was prepared by a “seed and growth” emulsion polymerization process as follows: An 8 liter jacketed glass reactor was fitted with a stainless steel semi-helical stirrer, thermal couple temperature probe, water cooled condenser with nitrogen outlet, a nitrogen inlet, internal cooling capabilities, and hot water circulating bath. After reaching a jacket temperature of 70° C.±1° C. and a continuous nitrogen purge, the reactor was charged with 3,827.3 grams of distilled water and 7.65 grams of the anionic surfactant sodium dodecyl sulfate (available from Aldrich Chemicals). The stirrer was then set at 1800 RPM and maintained at this speed throughout the polymerization and the reactor contents controlled at 65° C.±1° C. by the internal cooling system. In a holding vessel, a monomer mixture comprised of methyl methacrylate (MMA)/methacrylic acid (MAA) of 99/1 parts was prepared with 1,130.78 grams of MMA (as received) and 11.42 grams of methacrylic acid (as received) for a total of 1,142.20 grams. About 10 percent of the total monomer, about 114 grams, was then charged into the reactor and stirred at 180 RPM for about 10 minutes. At this time a solution of 4.57 grams of ammonium persulfate (APS) and 18.28 grams of distilled water were rapidly injected to initiate polymerization. In about 30 seconds, the evidence of polymerization and seed formation was verified by a hazy appearance. In about 3 minutes after initiation, the remainder of the monomer mix was pumped into the reactor at a rate of about 8 grams per minute or for a total monomer feed time of about 128 minutes. The emulsion polymerization was then allowed to further stir at 180 RPM and 65° C.±1° C. for an additional 182 minutes to complete conversion of monomer. The reactor and contents was then cooled to about 20° C. and then stirred at 180 RPM for a 24 hour stress test. In about 15 hours the latex was found to have coagulated and rendered unusable.

Size of the latex particles prior to stress test, after complete synthesis, was measured by a Honeywell Microtrac UPA 150 and observed to be about 84 nanometers.

### Comparative Example II

### Synthetic Latex Example 16

A latex copolymer comprised of methyl methacrylate (MMA)/methacrylic acid (MAA) of 99/1 parts (by weight throughout unless otherwise indicated) was prepared in a 2 gallon reactor by a “seed and growth” emulsion polymerization process as follows: An 8 liter jacketed glass reactor was fitted with a stainless steel semi-helical stirrer, thermal couple temperature probe, water cooled condenser with nitrogen outlet, a nitrogen inlet, internal cooling capabilities, and hot water circulating bath. After reaching a jacket temperature of 70° C.±1° C. and a continuous nitrogen purge, the reactor was charged with 3,827.3 grams of distilled water and 7.65 grams of the anionic surfactant sodium dodecyl sulfate (available from Aldrich Chemicals). The stirrer was then set at 170 RPM and maintained at this speed for 48 minutes and the reactor contents controlled at 65° C.±1° C. by the internal cooling system. In a holding vessel, a monomer mixture comprised of methyl methacrylate (MMA)/methacrylic acid (MAA) of 99/1 parts was prepared with 1,130.78 grams of MMA (as received) and 11.42 grams of methacrylic acid (as received) for a total of 1,142.20 grams. About 10 percent of the total monomer, ˜114 grams, was then charged into the reactor and stirred at 170 RPM for about 5 minutes. At this time a solution of 4.57 grams of ammonium persulfate (APS) and 18.28 grams of distilled water were rapidly injected to initiate polymerization. In about 30 seconds, the evidence of polymerization and seed formation was verified by a hazy appearance. In about 5 minutes after initiation, the stirrer speed was reduced to 160 RPM and the remainder of the monomer mix was pumped into the reactor at a rate of about 8 grams per minute or for a total monomer feed time of about 128 minutes. At the end of monomer addition the latex was then allowed to further stir at 160 RPM and 65° C.±1° C. for an additional 133 minutes to complete conversion of monomer. The reactor and contents was then cooled to about 25° C. and the resulting latex removed. A fine powdered sample of copolymer product was isolated by freeze-drying techniques and submitted for characterization. A latex sample, −250 ml, was placed in a storage container and checked once a week for stability. In about 32 days the onset of latex destabilization was verified by viscosity increase, followed by complete collapse of latex stability within 4 days.

Molecular weight (M_{w}) was determined by gel permeation chromatography to be 651,000, with M_{WD}=2.1. The resulting copolymer was found to have a glass transition of 117.5° C. as measured on a Seiko DSC. Acid number was 8.9 milligrams KOH/g as determined by titration with methanolic sodium hydroxide. Size of the latex particles produced were measured by a Honeywell Microtrac UPA 150 and observed to be about 91 nanometers.

### Example III

### Synthetic Example 62

### Cationic Initiated

A latex copolymer comprised of methyl methacrylate (MMA)/methacrylic acid (MAA) of 99/1 parts (by weight throughout unless otherwise indicated) was prepared in a 2 liter reactor by a “seed and growth” emulsion polymerization process as follows: An 2 liter jacketed glass reactor was fitted with a stainless steel semi-helical stirrer, thermal couple temperature probe, water cooled condenser with nitrogen outlet, a nitrogen inlet, internal cooling capabilities, and hot water circulating bath. After reaching a jacket temperature of 84° C.±1° C. and a continuous nitrogen purge, the reactor was charged with 1009.92 grams of distilled water and 2.01 grams of the anionic surfactant sodium dodecyl sulfate (available from Aldrich Chemicals). The stirrer was then set at 140 RPM and maintained at this speed for about 90 minutes and the reactor contents controlled at 80° C.±1° C. by the internal cooling system. In a holding vessel, a monomer mixture comprised of methyl methacrylate (MMA)/methacrylic acid (MAA) of 99/1 parts was prepared with 297.55 grams of MMA (as received) and 3.01 grams of methacrylic acid (as received) for a total of 300.56 grams. About 10 percent of the total monomer, ˜30 grams, was then charged into the reactor and stirred at 140 RPM for about 6 minutes. At this time a solution of about 0.50 grams of 2,2′-Azobis(2-methylpropionamidine)dihydrochloride and 2.0. grams of distilled water were rapidly injected to initiate polymerization. In about 60 seconds, the evidence of polymerization and seed formation was verified by a hazy appearance. In about 7 minutes after initiation, the stirrer speed was maintained at 140 RPM and the remainder of the monomer mix was pumped into the reactor at a rate of about 2.1 grams per minute or for a total monomer feed time of about 128 minutes. At the end of total monomer addition the latex was then allowed to further stir at 140 RPM and 80° C.±1° C. for an additional 135 minutes to complete conversion of monomer. The reactor and contents was then cooled to about 25° C. and the resulting latex removed. A fine powdered sample of copolymer product was isolated by freeze-drying techniques and submitted for characterization. A latex sample, ˜900 ml, was placed in a storage container and checked initially once a week for stability for a total of 8 weeks. No observed latex destabilization was seen. A sample was measured by a Honeywell Microtrac UPA 150 and observed to be about 80 nanometers. The same sample above was remeasured about 4 years post synthesis by a Honeywell Microtrac UPA 150 and observed to be about 81 nanometers, thus verifying superior stability.

Molecular weight (M_{w}) was determined by gel permeation chromatography to be about 756,000. The resulting copolymer was found to have a glass transition of about 117° C. as measured on a Seiko DSC. Acid number was about 9.0 milligrams KOH/g as determined by titration with methanolic sodium hydroxide. Size of the latex particles produced were measured by a Honeywell Microtrac UPA 150 and observed to be about 80 nanometers.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

1. A composition for coating carrier particles comprising:
an acrylic-based polymeric powder including a surfactant and a cationic initiator, wherein the acrylic-based polymeric powder is obtained from an emulsion of an acrylic- based polymer, the surfactant and the cationic initiator and the acrylic-based polymer is a methyl methacrylate copolymer formed from an acrylic acid or a methacrylic acid; and
a conductive filler, wherein the composition for coating carrier particles comprises the acrylic-based polymer, the surfactant and the cationic initiator in an amount of from about 0.18 percent to about 3.0 percent by weight of the total weight of the carrier coating composition.

2. (canceled)

3. The composition of claim 1, wherein the cationic initiator is 2,2′-Azobis(2-methylpropionamidine)dihydrochloride.

4. The composition of claim 1, wherein the cationic initiator is selected from the group consisting of 2,2′-azobis(N,N′-dimethylene isobutyramidine)dihydrochloride, 2,2′-azobis(2-amidinopropane)dihydrochloride, 2,2′-azobis(N,N′-dimethylene isobutyramidine), 2,2′-azobis-2-methyl)-N-[1,1 bis(hydroxymethyl]propionamide, 2,2′-azobis-2-methyl-N[1,1 bis(hydroxymethyl)ethyl]propionamide, 2,2′-azobis(isobutyramide)dehydrate, 2,2′-azobis(2-methyl-N-phenylpropionamidine)dihydrochloride, 2,2′-azobis[N-(4-chlorophenyl)-2-methylpropionamidine]di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride and 2,2′-azobis{2-[1-(2-hydroxyethyl)-2-imidazolin-2-yl]propane}dihydrochloride.

5. (canceled)

6. The composition of claim 1, wherein the conductive filler is selected from the group consisting of metal oxides.

7. The composition of claim 6, wherein the conductive filler is carbon black.

8. The composition of claim 1, wherein the composition comprises the conductive filler in an amount of from about 10 percent to about 60 percent by weight of the total weight of the composition.

9. The composition of claim 8, wherein the composition comprises the conductive filler in an amount of from about 10 percent to about 25 percent by weight of the total weight of the composition.

10. The composition of claim 8 further including charge enhancing additives, wherein the additives are fluoro polymer powders or fluorinated polymers.

11. The composition of claim 10, wherein the fluorinated polymers are selected from group consisting of polyvinylidine fluoride (PVF₂), poly(tetrafluoroethylene), fluoroalkyl methacrylates, and mixtures thereof.

12. A composition for coating carrier particles comprising:
a generally uniform dispersion of from about 0.18 percent to about 3.0 percent by weight of the carrier coating composition of an acrylic-based polymeric powder, a surfactant and a cationic initiator; and
a conductive filler of from about 10 percent to about 25 percent by weight of the carrier coating composition, wherein the cationic initiator is 2,2′-Azobis(2-methylpropionamidine)dihydrochloride.

13-25. (canceled)

26. The composition of claim 1, wherein the acrylic-based polymeric powder has a particle size of from about 1 micrometer to about 7 micrometers.

27. The composition of claim 26, wherein the acrylic-based polymeric powder has a particle size of from about 1 micrometer to about 6 micrometers.

28. The composition of claim 8 further including charge enhancing additives are present in an amount of from about 0.01 percent to about 15.0 percent by weight of the total weight of the composition.
